(19) United States
(12) Patent Application Publication
(10) Pub. No.: US 2022/0053736 A1
(43) Pub. Date: Feb. 24, 2022

(54) Intelligent Dog Training Apparatus and Control Method Thereof

(71) Applicant: Guangdong Lin Sheng Intelligent Technology Limited, Dongguan (CN)

(72) Inventors: Jianglin Xiao, Dongguan (CN); Gaofei Huang, Dongguan (CN)

(21) Appl. No.: 17/344,910

(22) Filed: Jun. 10, 2021

(30) Foreign Application Priority Data
Aug. 18, 2020 (CN) 202010829722.3

(51) Int. Cl. A01K 27/00; A01K 15/02

(52) U.S. Cl. CPC A01K 27/009; G08C 17/02; A01K 15/021

(57) ABSTRACT

Embodiments of the disclosure provide an intelligent dog training apparatus and a control method thereof. The intelligent dot training apparatus includes a transmitter and receivers. In the disclosure, a single transmitter is adopted to collectively control one or multiple receivers, achieving effective control on multiple pets at the same time. Function buttons are locked through a lock button set in the transmitter to prevent incorrect operations. The vibration frequency and electric shock strength can be optionally adjusted, thereby facilitating use. Control states and power can be observed through a display screen, achieving high practicality.

### CROSS REFERENCE TO RELATED APPLICATIONS

The present application claims the benefit of Chinese Patent Application No. 202010829722.3 filed on Aug. 18, 2020, the contents of which are incorporated herein by reference in their entirety.

### TECHNICAL FIELD

The disclosure relates to a pet training device, in particular to an adjustable multi-functional intelligent dog training apparatus and a control method thereof.

### BACKGROUND

With the continuous progress of society and the continuous improvement of people's living standards, more and more people keep pet dogs in the house. During keeping, pet dogs may often destroy indoor furniture or urinate or defecate in the house. Therefore, in order to train the pet dogs to form good habits, an appropriate system training is required for them. Because dogs are naturally curious, they are very easily affected by the outside world during the training, which makes them unable to concentrate, thereby greatly reducing the training effect. In order to improve the training effect, it is necessary to use a dog training apparatus specially used in training. The dog training apparatus generally includes a transmitter and a receiver. Transmitters on the market each can only control one single receiver. When training of multiple pet dogs is needed, multiple remote controllers are required for separate control, which are inconvenient to carry and use. The existing apparatus has a single function, cannot adapt to more complicated scenes, is prone to remote control failure, and is inconvenient in operation and easy to result in incorrect operations. In addition, the electric shock strength and vibration frequency cannot be adjusted.

### SUMMARY

Embodiments of the disclosure provide a pet training device to solve the problems that a transmitter in the conventional art can only control a single receiver; when training of multiple pet dogs is needed, multiple remote controllers are required for separate control, which are inconvenient to carry and use; remote control failure is easy to cause, operation is inconvenient, incorrect operations are easy to happen, and the electric shock strength and vibration frequency cannot be adjusted.

In a first aspect, the embodiments of the disclosure provide an intelligent dog training apparatus, including a transmitter and at least one receiver matched with the transmitter; and the transmitter and the at least one receiver are in communication connection through wireless signals.

The receiver includes a receiver shell, a receiving unit, a sounding component, a vibration motor, and a plurality of electric shock heads; the receiving unit, the sounding component, and the vibration motor are mounted in the receiver shell, and the receiving unit is connected to the electric shock heads, the sounding component, and the vibration motor.

The transmitter includes a transmitter shell, and a transmitting unit and a control unit both arranged in the transmitter shell and electrically connected to each other. The control unit is connected to a pairing selection button, a vibration button, a sound button, an electric shock button, and an electric shock strengthening button. In a pairing state, the pairing selection button searches for one or multiple receivers, matched with the transmitter, within an effective control range of the transmitter, and establishes a connection with the one or multiple receivers; in a selecting state, the pairing selection button selects to lock any one of the receivers that establish a connection with the transmitter to enable the receiving unit on the receiver that is selected to be locked to receive a control signal sent by the transmitting unit on the transmitter, and transmits the control signal to the electric shock heads or the vibration motor or the sounding component. The vibration button is configured to generate a vibration control signal, and the vibration control signal is sent to the receiver through the transmitting unit, so as to drive the vibration motor on the receiver to work. The sound button is configured to generate a sound control signal for controlling the receiver to make a sound. The electric shock button is configured to generate a shock control signal, and the shock control signal is sent to the receiver through the transmitting unit, so as to drive the electric shock heads on the receiver to work. The electric shock strengthening button is configured to generate a strength increasing signal according to a first preset proportion, and the strength increasing signal is sent to the receiver through the transmitting unit, so that an electric shock strength of each of the electric shock heads in a working state currently is increased according to the first preset proportion.

Preferably, the transmitter includes a first PCB (Printed Circuit Board) mounted in the transmitter shell, the control unit is arranged on the first PCB, the transmitting unit includes an antenna arranged on the outer side of the transmitter shell, a switch connected to the control unit is also arranged on the outer side of the transmitter shell, and the antenna is electrically connected to the control unit.

Preferably, the transmitter shell is further provided with a display screen, and the display screen is configured to at least display a real-time pairing state of the transmitter and the receiver, a selection locking state, an electric shock strengthening state, a vibration strength state, and a power state.

The transmitter shell is further provided with mode adjustment buttons, and the mode adjustment buttons include a vibration adjustment button and an electric shock adjustment button both arranged on a first side of the transmitter shell; the vibration adjustment button is configured to generate a vibration frequency signal for adjusting a vibration frequency of the vibration motor, and the electric shock adjustment button is configured to generate an electric shock strength signal for adjusting the electric shock strength of each of the electric shock heads.

A lock button and an unlock button both electrically connected to the control unit are arranged on a second side of the transmitter shell; the lock button is configured to enable the transmitter to enter a lock state when receiving a lock operation instruction to shield signals of other buttons except that of the unlock button, so that the transmitter cannot transmit signals to the receiver and cannot carry out pairing selection and mode selection; the signals include the sound control signal, an electric shock strength increasing signal, the electric shock strength signal, and the vibration frequency signal; and the unlock button is configured to release the lock state when receiving an unlock operation instruction.

Preferably, the electric shock heads may be detachably covered with conductive rubber sleeves or insulating silicone sleeves, respectively.

Preferably, the receiver is provided with a magnetic charger connector, a storage battery and a charging indicator light both electrically connected to the magnetic charger connector, and mode LED lights for displaying a pairing mode and a charging mode.

The transmitter is provided with a Micro interface for charging, a storage battery and a charging indicator light both electrically connected to the Micro interface, and mode LED lights for displaying a pairing mode and a charging mode.

Preferably, the control unit includes a master control module, and a switch module, a vibration adjustment module, an electric shock adjustment module, a selection module, a lock module, a sound module, and a transmission module which are respectively electrically connected to the master control module.

The transmission module is connected to the antenna, and configured to receive signals generated by the switch module, the vibration adjustment module, the electric shock adjustment module, the selection module, and the sound module, and send the signals to the receiver.

The switch module is electrically connected to the switch, and an on or off state of the transmitter is controlled by rotating the switch; the vibration adjustment module is electrically connected to the vibration adjustment button, and vibration gears of the transmitter are adjusted by rotating the switch when the vibration adjustment button is pressed and held, so that a vibration frequency of the receiver is controlled.

The electric shock adjustment module is electrically connected to the electric shock adjustment button, and electric shock gears are adjusted by rotating the switch when the electric shock adjustment button is pressed and held, so that an electric shock strength of the receiver is controlled.

The selection module is electrically connected to the pairing selection button, the selection module is controlled to select any one of the receivers connected to the transmitter by pressing and holding the pairing selection button while rotating the switch, so that the receiver that is selected to be locked is controlled.

The sound module is electrically connected to the sound button, and a sound control signal is generated by pressing and holding the sound button, and is transmitted to the transmission module.

The lock module is electrically connected to the lock button and the unlock button, and is controlled to lock the pairing selection button, the mode adjustment button, the sound button, the vibration button, the electric shock button, and the electric shock strengthening button on the transmitter through the lock button and the unlock button, so as to temporarily disable corresponding functions, or unlock these buttons to recover their functional operations.

Preferably, the receiver includes a second PCB mounted in the receiver shell, and the second PCB is provided with an electric shock module, a vibration module, and a sounding module which are electrically connected with the receiving unit; the electric shock module is configured to receive an electric shock strength signal sent by the electric shock adjustment module to drive the electric shock heads that are electrically connected to the electric shock module to carry out an electric shock operation; the vibration module is configured to receive the vibration frequency signal sent by the vibration adjustment module to drive the vibration motor that is electrically connected to the vibration module to carry out an vibration operation; the sounding module is electrically connected to the sounding component and configured to receive the sound control signal and control the sounding component to make a sound.

Preferably, the receiver shell is provided with a top cap, the top cap is provided with a plurality of sound holes at positions corresponding to the sounding component, and the sounding component refers to a loudspeaker or a buzzer.

Preferably, the plurality of electric shock heads are respectively arranged on a bottom side of the transmitter shell, a protrusion is integrally molded at the bottom of the transmitter shell, and located on the other side, opposite to the plurality of electric shock heads, and the plurality of electric shock heads and the protrusion form a triangular structure so that contact degree and electric shock stability are improved.

Preferably, the magnetic charger connector is arranged on the protrusion.

Preferably, tops of the plurality of electric shock heads are located at the same horizontal position to keep an effective contact; and the plurality of electric shock heads are arranged at the bottom of the transmitter shell, and distributed in the middle of the bottom of the transmitter shell.

Preferably, the master control module is configured to transmit control signals, generated through operations of the pairing selection button, the mode adjustment button, the sound button, the vibration button, the electric shock button, and the electric shock strengthening button, of the transmitter, and send the control signals to one or multiple receivers matched with the transmitter; the receiving unit in the receiver, which is in wireless communication connection with the master control module, receives the signals transmitted by the master control unit so that a wireless communication connection between the transmitter and the receiver is performed.

In a second aspect, the embodiments of the disclosure provide a control method based on the intelligent dog training apparatus described in the first aspect of the disclosure, and the control method includes the following steps.

(1) Startup includes: rotating a switch on a transmitter to turn on the transmitter, pressing the switch of a receiver matched with the transmitter to turn on the receiver; on a display screen, displaying a real-time power icon of the transmitter, and a real-time power icon of the receiver matched with the transmitter during pairing of the receiver and the transmitter; and initially controlling parameters which include an electric shock strength and a vibration frequency.

(2) Selection includes: after pairing is completed, pressing a pairing selection button, rotating the switch to allow the corresponding icon of the receiver to flash on the display screen until the receiver is selected.

(3) Adjustment includes: pressing a vibration adjustment button or an electric shock adjustment button to switch the transmitter into a corresponding mode, and rotating the switch to adjust gears until reaching a vibration amplitude or electric shock strength required for training.

(4) Training includes: when a pet wears the receiver, according the actual training, pressing and holding the vibration adjustment button while rotating the switch to adjust the vibration gears of the transmitter so as to generate a vibration frequency signal, then pressing the vibration button to generate a vibration control signal based on the vibration frequency signal, sending the vibration control signal to the receiver, and after the receiver receives the vibration control signal, driving a vibration motor to achieve vibration with a corresponding strength.

The training further includes: pressing and holding the electric shock button while rotating the switch to adjust electric shock gears of the transmitter to generate an electric shock strength signal; pressing the electric shock button to generate an electric shock control signal based on the electric shock strength signal; sending the electric control signal to the receiver, and after the receiver receives the electric shock control signal, driving the electric shock heads to carry out an electric shock with a corresponding strength.

When the vibration frequency or electric shock strength exceeds a preset value, a warning icon of the transmitter will flash on the display screen.

When the sound button on the transmitter is pressed, the receiver sends a prompt sound to warn the pet, so that the pet may stay still.

(5) Standby includes: covering the electric shock heads with insulating silicone sleeves when training is not required.

(6) Shutdown includes: rotating the switch on the transmitter to turn off the transmitter, and pressing a power switch on the receiver for 3 s to turn off the receiver.

(7) Charging includes: in the case of a low power, giving a low-power warning, charging the transmitter through a Micro interface, and charging the receiver through a magnetic charger connector.

The embodiments of the disclosure provide an intelligent dog training apparatus and a control method thereof, having the following effects.

1. The apparatus integrally uses a single transmitter to collectively control multiple receivers, achieving effective control from a traditional one to one mode to a mode of one to multiple.

2. The lock button and the unlock button are arranged in the transmitter to lock or unlock the function buttons, preventing the incorrect operations.

3. The vibration frequency and electric shock strength of the apparatus can be optionally adjusted, thereby facilitating use. The apparatus is of a simple structure, and convenient to operate. A control state of the whole apparatus can be observed through the display screen.

4. Each receiver is of a compact structure, is provided with the magnetic charger connector for charging itself, and has high waterproof capacity and strong practicability.

5. The electric shock strength can be adjusted, and the electric shock output can be increased by 10% of an original set value.

6. Both the transmitter and the receivers are provided with power display.

### BRIEF DESCRIPTION OF THE DRAWINGS

In order to describe the technical solutions in the embodiments of the disclosure or the conventional art more clearly, the drawings required to be used in descriptions about the embodiments or the conventional art will be simply introduced below. Obviously, the drawings in the following descriptions are some embodiments of the disclosure. Those of ordinary skill in the art can further obtain other drawings according to these drawings without creative work.

FIG. 1 is a schematic diagram of an implementation manner of an overall structure of a transmitter according to an embodiment of the disclosure.

FIG. 2 is a schematic diagram of another implementation manner of the overall structure of the transmitter according to the embodiment of the disclosure.

FIG. 3 is a rear view of the overall structure of the transmitter according to the embodiment of the disclosure.

FIG. 4 is a schematic diagram of an overall structure of a receiver with a protrusion according to an embodiment of the disclosure.

FIG. 5 is a schematic diagram of a bottom structure of the receiver with a protrusion according to the embodiment of the disclosure.

FIG. 6 is a schematic diagram of an overall structure of a receiver without a protrusion according to an embodiment of the disclosure.

FIG. 7 is a schematic diagram of a bottom structure of the receiver without a protrusion according to the embodiment of the disclosure.

FIG. 8 is a schematic circuit diagram of a receiver according to an embodiment of the disclosure.

FIG. 9 is a schematic circuit diagram of a transmitter according to an embodiment of the disclosure.

FIG. 10 is a schematic diagram of a startup method of a transmitter and a receiver according to an embodiment of the disclosure.

FIG. 11 is an operation schematic diagram of a pairing selection button according to an embodiment of the disclosure.

FIG. 12 is a schematic diagram of a pairing selection operation between one transmitter and multiple receivers according to an embodiment of the disclosure.

FIG. 13 is a diagram showing a selection effect of one transmitter controlling multiple receivers according to an embodiment of the disclosure.

FIG. 14 is a schematic diagram of control after a pairing pair is selected according to an embodiment of the disclosure.

FIG. 15 is a schematic diagram of sound control according to an embodiment of the disclosure.

FIG. 16 is a schematic diagram of a vibration control effect according to an embodiment of the disclosure.

FIG. 17 is a schematic diagram of an electric shock control effect according to an embodiment of the disclosure.

FIG. 18 is a diagram showing display states of a display screen according to an embodiment of the disclosure.

FIG. 19 is a schematic diagram of operations of a lock button and an unlock button according to an embodiment of the disclosure.

FIG. 20 is a schematic diagram of resetting every paired receiver according to an embodiment of the disclosure.

### REFERENCE SIGNS IN THE DRAWINGS

1-transmitter; 2-receiver; 3-transmitter shell; 4-control unit; 5-switch; 6-antenna; 7-lock button; 8-unlock button; 9-pairing selection button; 10-mode adjustment button 11-vibration adjustment button; 12-electric shock adjustment button; 13-display screen; 14-sound button; 15-vibration button; 16-electric shock button; 17-electric shock strengthening button; 18-receiver shell; 19-electric shock head; 20-power switch; 36-top cap; 37-sound hole; 38-protrusion; and 40-magnetic charger connector.

### DETAILED DESCRIPTION OF THE EMBODIMENTS

In order to make the objectives, technical solutions, and advantages of the embodiments of the disclosure clearer, the technical solutions in the embodiments of the disclosure will be clearly and completely described below in combination with the drawings in the embodiments of the disclosure. Obviously, the described embodiments are not all embodiments but part of embodiments of the disclosure. All other embodiments obtained by those of ordinary skilled in the art on the basis of the embodiments in the disclosure without creative work shall fall within the scope of protection of the disclosure.

Term “and/or” in the embodiments of this application is only an association relationship describing associated objects and represents that three relationships may exist. For example, A and/or B may represent that A exists alone, A and B exist at the same time, and B exists alone.

In the embodiments of this application, terms “first” and “second” are only adopted for description and should not be understood to indicate or imply relative importance or implicitly indicate the number of indicated technical features. Therefore, a feature defined by “first” and “second” may explicitly or implicitly indicate inclusion of at least one such feature. In the description of this application, terms “include” and “have” and any variations thereof are intended to cover non-exclusive inclusions. For example, a system, product or device including a series of components or units is not limited to the components or units which are listed, but may alternatively further include components or units which are not listed or alternatively further include other components or units intrinsic to the product or device. In the descriptions of this application, “multiple” means at least two, for example, two and three, unless otherwise limited definitely and specifically.

“Embodiment” mentioned in the disclosure means that a specific characteristic, structure or property described in combination with the embodiment may be included in at least one embodiment of this application. Appearance of this phrase at each position in the specification may not always mean the same embodiment as well as an independent or alternative embodiment mutually exclusive with the other embodiments. Those skilled in the art explicitly and implicitly understand that the embodiments described in the disclosure may be combined with the other embodiments.

Transmitters on the current market each can only control a single receiver. When training of multiple pet dogs is needed, multiple remote controllers are required for separate control, which are inconvenient to carry and use. Remote control failure is easy to cause, operation is inconvenient, and incorrect operations are easy to happen. The electric shock strength and vibration frequency cannot be adjusted. In addition, the receiver is poor in waterproof performance, and easy to be damaged by water, and has poor practicability.

Therefore, the embodiments of the disclosure provide an intelligent dog training apparatus and a control method thereof. The apparatus integrally uses a single transmitter to collectively control multiple receivers, achieving effective control on multiple pets at the same time. A lock button and an unlock button are arranged in the transmitter to lock or unlock function buttons, preventing the incorrect operations. The vibration frequency and electric shock strength of the apparatus can be optionally adjusted, thereby facilitating use. The apparatus is of a simple structure, and convenient to operate. A control state of the whole apparatus can be observed through a display screen. Each of the receivers is of a compact structure, is provided with a magnetic charger connector for charging itself, and has high waterproof capacity and strong practicability. In the following, a plurality of embodiments will be used for description and introduction.

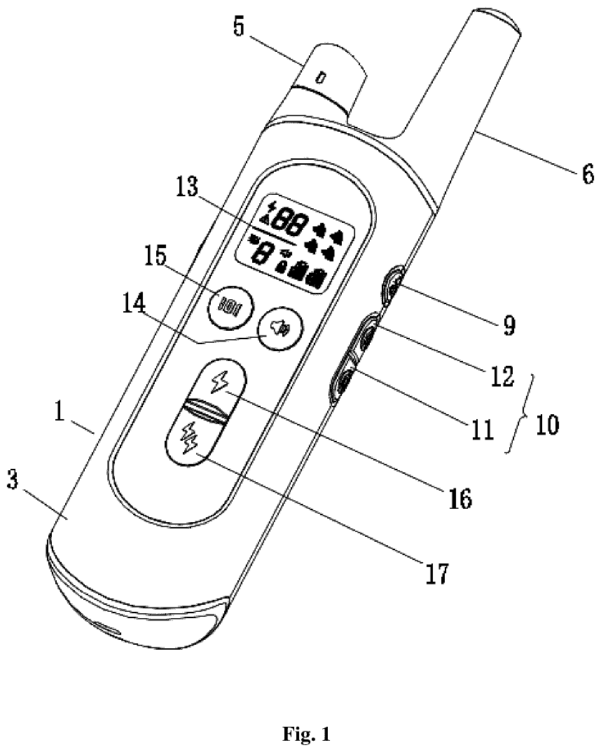

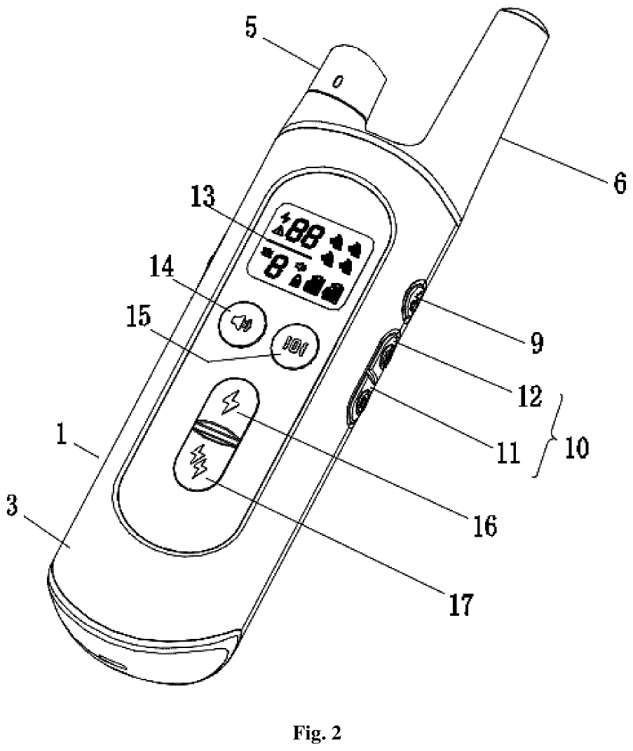

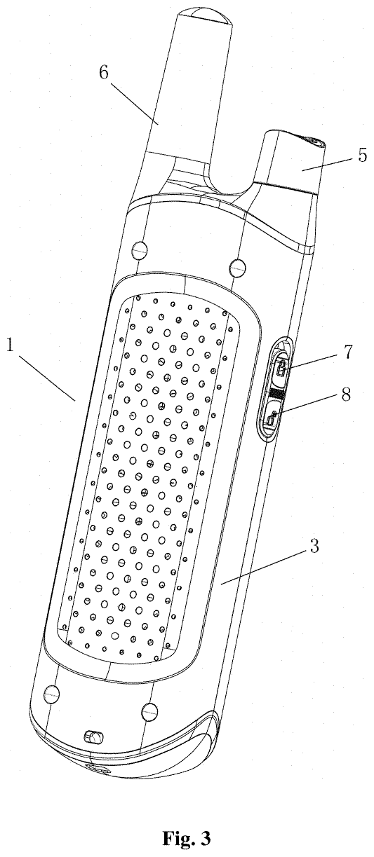

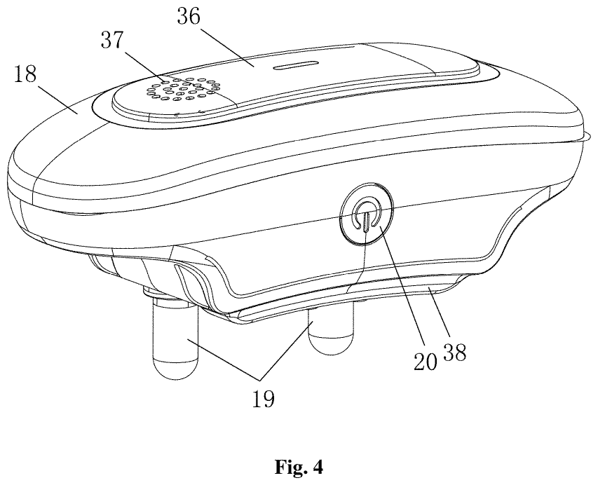

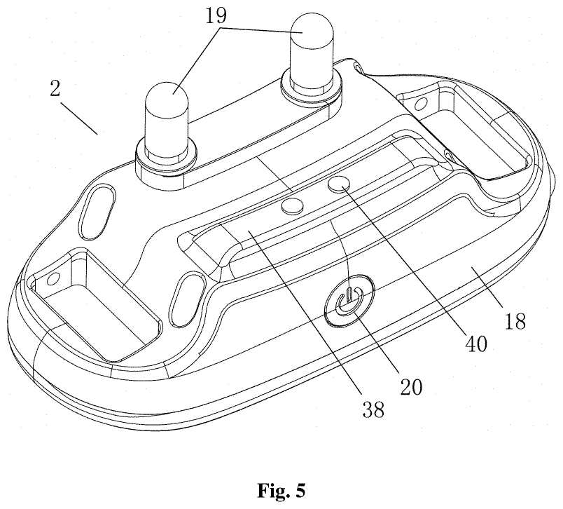

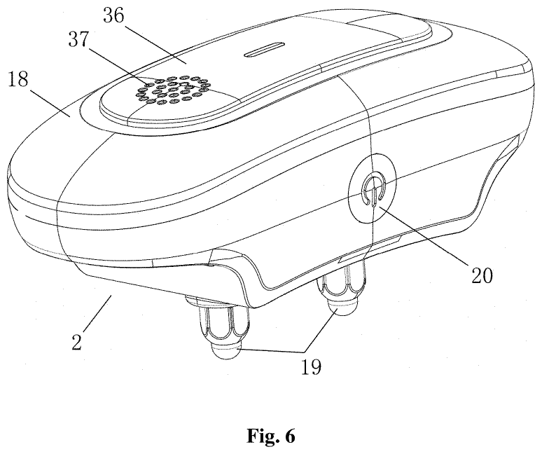

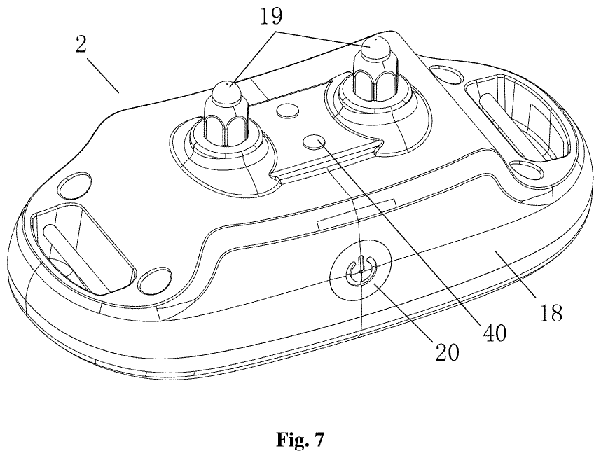

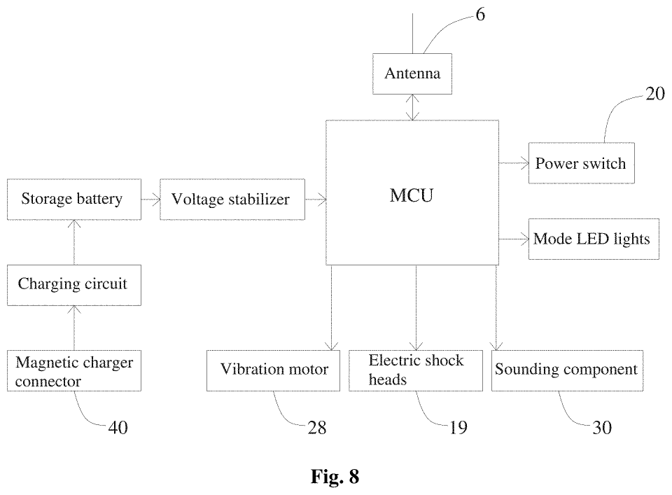

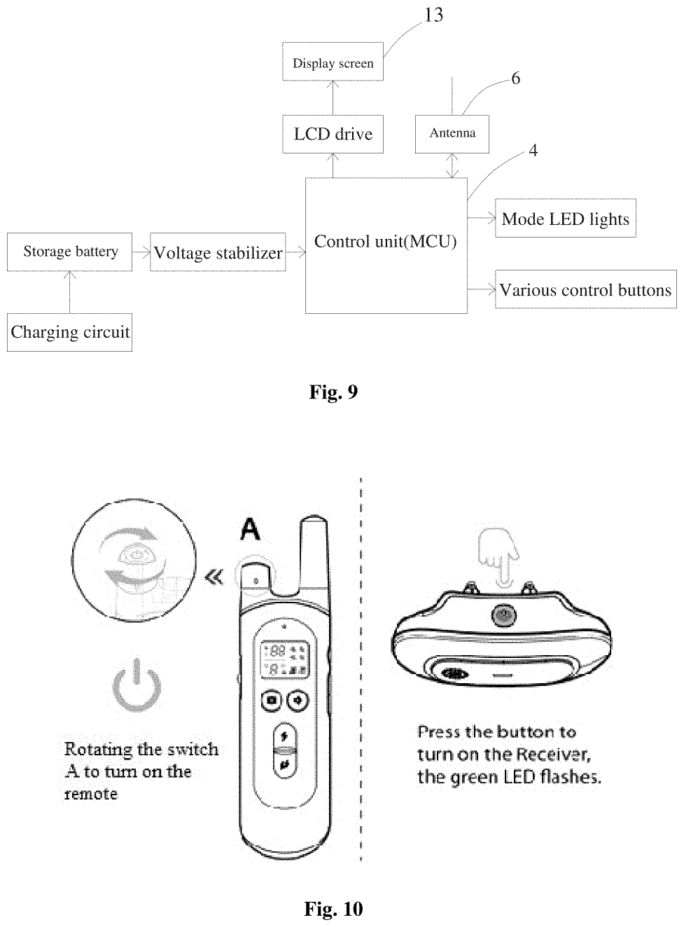

As shown in FIG. 1 to FIG. 8, the embodiments of the disclosure provide an intelligent dog training apparatus, including a transmitter 1 and at least one receiver 2 matched with the transmitter 1. The transmitter 1 and the receiver 2 are in communication connection through wireless signals; the receiver includes a receiver shell 18, a receiving unit, a vibration motor, and a plurality of electric shock heads 19, the receiving unit and the vibration motor are mounted in the receiver shell 18, and the receiving unit is connected to the electric shock heads 19 and the vibration motor; the receiver shell 18 is provided with a power switch 20, the electric shock heads 19 can be detachably covered with conductive silicon sleeves or insulating silicone sleeves, and the receiver 2 is provided with a magnetic charger connector 40 for charging itself. The transmitter 1 includes a transmitter shell 3 and a control unit 4 arranged in the transmitter shell 3. The transmitter 1 includes a switch 5 and an antenna 6 which are located on the top of the transmitter shell 3 and electrically connected to the control unit 4. A lock button 7 and an unlock button 8 both electrically connected to the control unit 4 (as shown in FIG. 9) are arranged on one side of the transmitter shell 3; a pairing selection button 9 and mode adjustment buttons 10 both electrically connected to the control unit 4 are arranged on the other side of the transmitter shell 3. The mode adjustment buttons 10 include a vibration adjustment button 11 and an electric shock adjustment button 12; the vibration adjustment button 11 is configured to generate a vibration frequency signal for adjusting a vibration frequency of the vibration motor; the electric shock adjustment button 12 is configured to generate an electric shock strength signal for adjusting an electric shock strength of each of the electric shock heads 19. The transmitter shell 3 is provided with a display screen 13, and is further provided with a sound button 14, a vibration button 15, an electric shock button 16, and an electric shock strengthening button 17. The pairing selection button 9 is configured to select to lock one or multiple receivers 2 matched with the transmitter 1 before each training. The mode adjustment buttons 10 are configured to select a working mode of the transmitter 1, so that the plurality of electric shock heads 19 and/or the plurality of vibration motors of the receiver 2 selected to be locked are controlled according to the working mode. In a pairing state, the pairing selection button 9 searches for one or multiple receivers 2, matched with the transmitter 1, within an effective control range of the transmitter 1, and establishes a connection with the one or multiple receivers 2; in a selecting state, the pairing selection button 9 selects to lock any of the receivers 2 that establish a connection with the transmitter 1 to enable a receiving unit on the receiver 2 that is selected to be locked to receive a control signal sent by a transmitting unit on the transmitter 1, and transmits the control signal to the electric shock heads 19 or the vibration motor. Herein, in this embodiment, the sound button 14 is arranged on the left of the vibration button 15 (as shown in FIG. 1); in the other embodiments, positions of the sound button 14 and the vibration button 15 can be exchanged by a user according to actual training requirements, that is, the vibration button 15 is arranged on the left of the sound button 14 (as shown in FIG. 2). The vibration button 15 is configured to generate a vibration control signal, and send the vibration control signal to the receiver 2 through the transmitting unit, so as to drive the vibration motor on the receiver 2 to work; the electric shock button 16 is configured to generate an electric shock control signal, and send the electric shock control signal to the receiver 2 through the transmitting unit, so as to drive the electric shock heads 19 on the receiver 2 to work; the electric shock strengthening button 17 is configured to generate a strength increasing signal according to a first preset proportion (for example, 10% is increased for each press), and send the strength increasing signal to the receiver 2 through the transmitting unit, so that the vibration frequency or electric shock strength of each of the electric shock heads 19 in a working state currently is increased according to the first preset proportion.

In this embodiment, the apparatus integrally uses a single transmitter 1 to collectively control multiple receivers 2, achieving effective control on multiple pets at the same time. The lock button 7 and the unlock button 8 arranged in the transmitter 1 can lock or unlock the function buttons. The lock button 7 is configured to enable the transmitter to enter a lock state when receiving a lock operation instruction to shield signals of other buttons except that of the unlock button, so that the transmitter cannot transmit signals to the receivers 2; the signals include the sound control signal, the strength increasing signal, the electric shock strength signal, and the vibration frequency signal; and the unlock button 8 is configured to release the lock state when receiving an unlock operation instruction. The incorrect operations can be avoided. The vibration frequency and electric shock strength of the apparatus can be optionally adjusted, thereby facilitating use. The apparatus is of a simple structure, and convenient to operate. A control state of the whole apparatus can be observed through the display screen. Each of the receivers is of a compact structure, is provided with a magnetic charger connector for charging itself, and has high waterproof capacity and strong practicability.

Based on the above embodiment, as a preferred implementation manner, each receiver 2 is provided with the magnetic charger connector 40, and a storage battery and a charging indicator both electrically connected to the magnetic charger connector 40. The magnetic charger connector 40 has a waterproof function.

Based on the above embodiment, as a preferred implementation manner, the transmitter includes a first Printed Circuit Board (PCB) mounted in the transmitter shell, the control unit is arranged on the first PCB, the transmitting unit includes an antenna arranged on the outer side of the transmitter shell, a switch connected to the control unit is also arranged on the outer side of the transmitter shell, and the antenna is electrically connected to the control unit.

Based on the above embodiment, as a preferred implementation manner, the control unit 4 includes a master control module, and a switch module, a vibration adjustment module, an electric shock adjustment module, a selection module, a lock module, a sound module, and a transmission module which are respectively electrically connected to the master control module.

The transmission module is connected to the antenna, and configured to receive signals generated by the switch module, the vibration adjustment module, the electric shock adjustment module, the selection module, and the sound module, and send the signals to the receiver.

The transmitter shell 3 is further provided with a display screen 13, and the display screen 13 is configured to at least display a real-time pairing state of the transmitter 1 and the receiver 2, a selection locking state, an electric shock strengthening state, a vibration strength state, and a power state.

The switch module is electrically connected to the switch 5, and an on or off state of the transmitter 1 is controlled by rotating the switch 5.

The vibration adjustment module is electrically connected to the vibration adjustment button 11, and vibration gears of the transmitter 1 are adjusted by rotating the switch 5 when the vibration adjustment button 11 is pressed and held, so that a vibration frequency of the receiver 2 is controlled.

The sound module is electrically connected to the sound button 14, and a sound control signal is generated by pressing the sound button 14, and is transmitted to the transmission module.

The electric shock adjustment module is electrically connected to the electric shock adjustment button 12, and electric shock gears are adjusted by rotating the switch 5 while pressing and holding the electric shock adjustment button 12 to switch into an electric shock mode, so that an electric shock strength of the receiver 2 is controlled.

The selection module is electrically connected to the pairing selection button 9, the selection module is controlled to select any one of the receivers 2 connected to the transmitter 1 by pressing and holding the pairing selection button 9 to switch into a selection mode while rotating the switch 5.

The lock module is electrically connected to the lock button 7 and the unlock button 8, and is controlled to lock the pairing selection button 9, the mode adjustment buttons 10, the sound button 14, the vibration button 15, the electric shock button 16, and the electric shock strengthening button 17 on the transmitter 1 through the lock button 7 and the unlock button 8, so as to temporarily disable corresponding functions, or unlock these buttons to recover their functional operations. The electric shock strengthening button 17 is configured to increase the electric shock strength of each of the electric shock heads 19 according to a first preset proportion.

Based on the above embodiment, as a preferred implementation manner, the receiver 2 is provided with a second PCB, a vibration motor, and a sounding component all mounted in the receiver shell 18, and the second PCB is provided with an electric shock module, a vibration module, a power supply module, and a sounding module which are electrically connected with a signal receiving module; the power supply module is electrically connected to a power supply component; the electric shock module is configured to receive an electric shock strength signal sent by the electric shock adjustment module to drive the electric shock heads 19 that are electrically connected to the electric shock module to carry out an electric shock operation; the vibration module is configured to receive the vibration frequency signal sent by the vibration adjustment module to drive the vibration motor that is electrically connected to the vibration module to carry out an vibration operation; the sounding module is electrically connected to the sounding component and receives the sound control signal to drive the sounding component to make a prompt sound.

Based on the above embodiment, as a preferred implementation manner, the receiver shell 18 is provided with a top cap 36, the top cap 36 is provided with a plurality of sound holes 37 located at the sounding component, and the sounding component may be loudspeaker or a buzzer.

Based on the above embodiment, as a preferred implementation manner, the plurality of electric shock heads 19 are respectively arranged on a bottom side of the transmitter shell 18, a protrusion 38 is integrally molded at the bottom of the transmitter shell 18, and located on the other side, opposite to the plurality of electric shock heads 19, and the plurality of electric shock heads 19 and the protrusion 38 form a triangular structure so that contact degree and electric shock stability are improved.

Based on the above embodiment, as a preferred implementation manner, the plurality of electric shock heads 19 are parallel one another, spaced by predetermined interval, arranged at the bottom of the receiver shell 18, and distributed in the middle of the bottom of the receiver shell 18.

Based on the above embodiment, as a preferred implementation manner, specifically two electric shock heads 19 are provided.

Based on the above embodiment, as a preferred implementation manner, the display screen 13 is provided with a display module, and is electrically connected to the display module, the display module is configured to display working states of corresponding modules in the control unit 4, and further configured to display a real-time controlled state of the receiver 2 connected to the transmitter 1. For example, receivers 2 are numbered in display, and the receiver 2 that is currently selected to be locked is distinguished/highlighted in display by a colored or bright mark; the display screen 13 displays outwards for observation through a window on the transmitter shell 3.

Based on the above embodiment, as a preferred implementation manner, the master control module is configured to transmit master control signals, generated through operations of the pairing selection button 9, the mode adjustment button 10, the sound button 14, the vibration button 15, the electric shock button 16, and the electric shock strengthening button 17, of the transmitter 1, and send the master control signals to the receiver 2 matched with the transmitter 1; a signal receiving module in the receiver 2, which is in wireless communication connection with the master control module, receives the master control signals, so that a wireless communication connection between the transmitter 1 and the receiver 2 is performed.

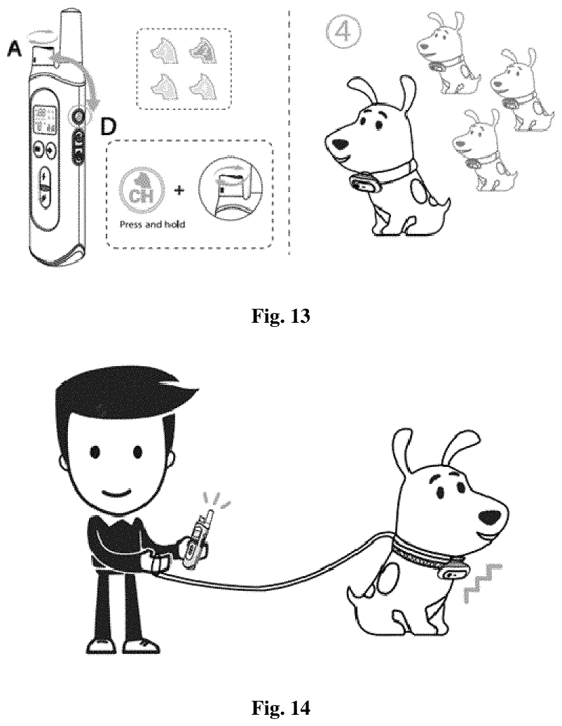

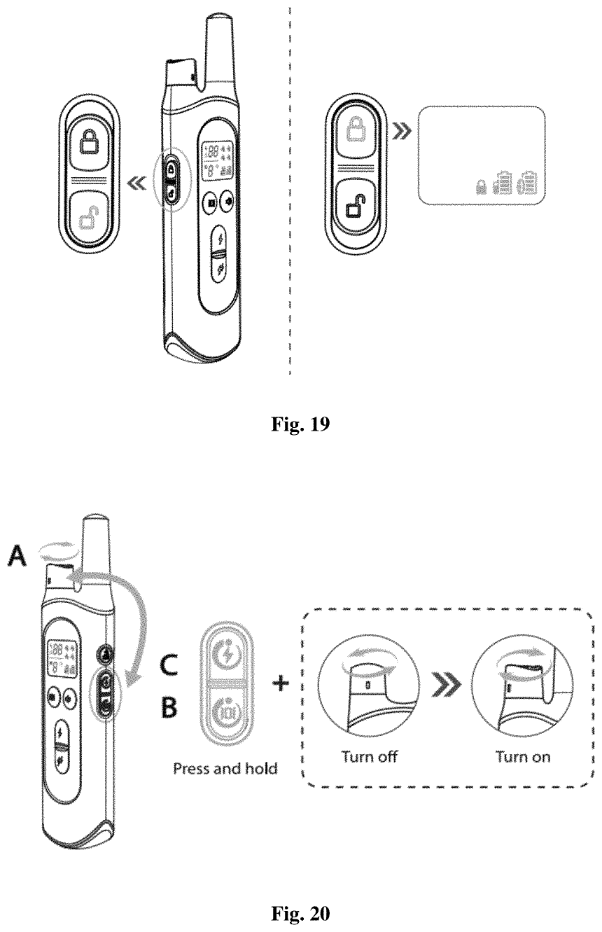

The embodiments of the disclosure further provides a control method based on the intelligent dog training apparatus according to the above various embodiments; as shown in FIG. 10 to FIG. 20, the control method includes the following steps.

(1) Startup includes: as shown in FIG. 10, rotating a switch 5 on a transmitter 1 to turn on the transmitter 1, pressing a power switch 20 of a receiver 2 matched with the transmitter 1 to turn on the receiver 2; on a display screen 13, displaying a real-time power icon of the transmitter 1, and a real-time power icon of the receiver 2 matched with the transmitter 1 during pairing of the receiver 2 and the transmitter 1; and initially controlling parameters which include an electric shock strength and a vibration frequency.

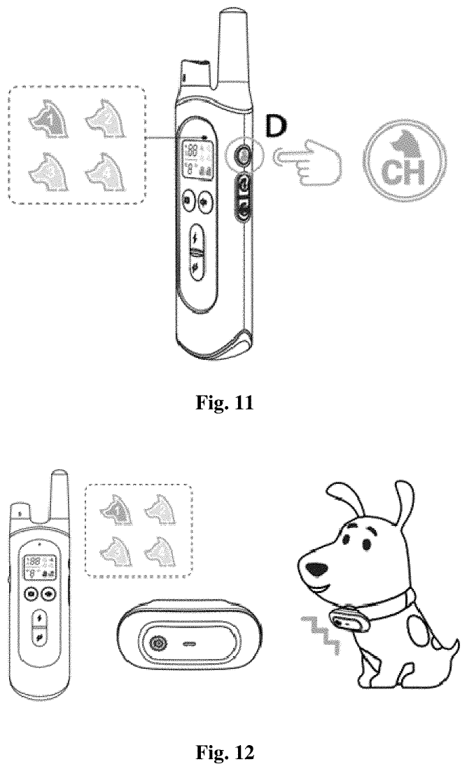

(2) Selection includes: as shown in FIG. 11 to FIG. 14, pressing a pairing selection button 9, rotating the switch 5 to allow the corresponding icon of the receiver 2 to flash on the display screen 13 until the target receiver 2 is selected.

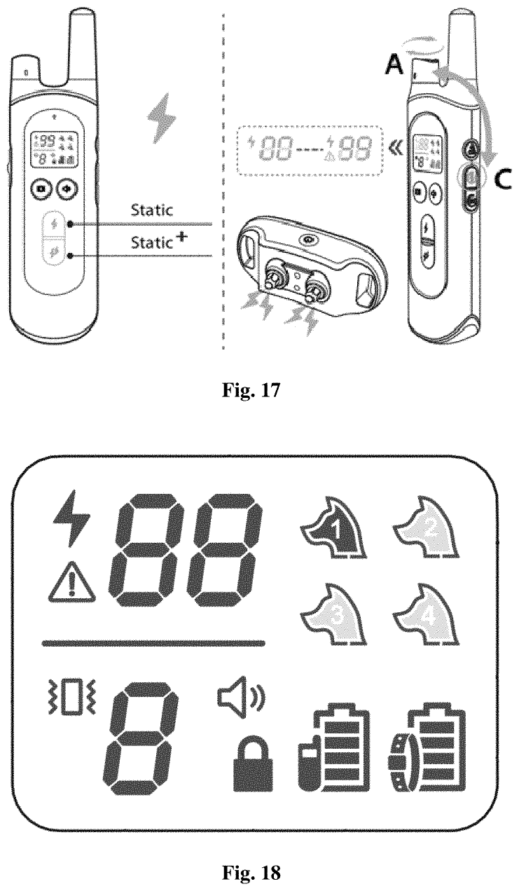

(3) Adjustment includes: as shown in FIG. 16 and FIG. 17, pressing a vibration adjustment button 11 or an electric shock adjustment button 12 to switch the transmitter 1 into a corresponding mode, rotating the switch 5 to adjust gears unit reaching a vibration amplitude or electric shock strength required for training; herein, vibration (a vibration icon at the bottom left corner), electric shock (at the top left corner), beep (a horn shape), receiver power (an icon with a collar at the bottom right corner), transmitter power (an icon with a transmitter at the bottom right corner), pairing targets for selection (at the top right corner), electric shock strength (at the bottom left corner), lock state (on the left side of the icon of transmitter power), and the like are displayed in the display screen, as shown in FIG. 18.

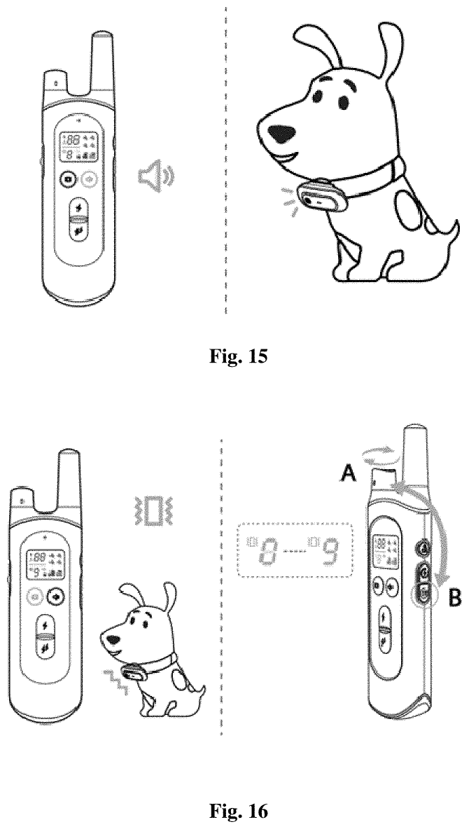

(4) Training includes: as shown in FIG. 15 to FIG. 17, when a pet wears the receiver, according the actual training, pressing and holding the vibration adjustment button while rotating the switch to adjust the vibration gears of the transmitter so as to generate a vibration frequency signal, then pressing the vibration button to generate a vibration control signal based on the vibration frequency signal, sending the vibration control signal to the receiver, and after the receiver receives the vibration control signal, driving a vibration motor to achieve vibration with a corresponding strength.

The training further includes: pressing and holding the electric shock button while rotating the switch to adjust electric shock gears of the transmitter to generate an electric shock strength signal; pressing the electric shock button to generate an electric shock control signal based on the electric shock strength signal; sending the electric control signal to the receiver, and after the receiver receives the electric shock control signal, driving the electric shock heads to carry out an electric shock with a corresponding strength.

When the vibration frequency or electric shock strength exceeds a preset value, an alarm icon of the transmitter will flash on the display screen.

When the sound button on the transmitter is pressed, the receiver sends a prompt sound to warn the pet, so that the pet may stay still.

(5) Standby includes: covering the electric shock heads with insulating silicone sleeves when training is not required.

(6) Shutdown includes: rotating the switch on the transmitter to turn off the transmitter, and pressing a power switch on the receiver for 3 s to turn off the receiver.

(7) Charging includes: in the case of a low power, giving a low-power warning, charging the transmitter through a Micro interface, and charging the receiver through a magnetic charger connector.

As shown in FIG. 20, on the premise of ensuring that the transmitter is turned on, the vibration adjustment button 11 and the electric shock button 12 are pressed and held simultaneously, while a switch A is adjusted to ON from OFF, so that all the paired receivers can be removed, and can be paired again.

Based on the above embodiment, as a preferred implementation manner, an intelligent dog training apparatus and a control method are provided. The apparatus integrally includes a transmitter 1 and receivers 2. The number of receivers 2 is optimally but not limited to four. In this embodiment, the number of receivers 2 is selected as four. The four receivers 2 are respectively connected to the transmitter 1 through wireless connection methods such as WIFI. The transmitter 1 is used as a remote controller for sending control signals, and the four receivers 2 are respectively used to receive the control signals sent by the transmitter 1 and perform related operations instructed by the signals.

Based on the above embodiment, as a preferred implementation manner, the transmitter 1 includes a transmitter shell 3 and a control unit 4 mounted in the transmitter shell 3. The control unit 4 includes a master control module, a switch module, a vibration adjustment module, an electric shock adjustment module, a selection module and a lock module, and the switch module, the vibration adjustment module, the electric shock adjustment module, the selection module and the lock module are respectively electrically connected to the master control module, and a control signal is transmitted through the master control module. A rotatable switch 5 and an antenna 6 are respectively arranged on the top of the transmitter shell 3. The switch 5 and the antenna 6 are respectively located on the left and right sides of the top of the transmitter shell 3. A lock button 7 and an unlock button 8 are arranged on the left side of the transmitter shell 3. The lock button 7 and the unlock button 8 are electrically connected to the lock module; by pressing and holding the lock button 7 or the unlock button 8 to trigger the lock module, a pairing selection button 9, mode adjustment buttons, a sound button 14, a vibration button 15, an electric shock button 16 and an electric shock strengthening button 17 on the control unit 4 are locked and cannot be operated or are unlocked to recover to an operable state. The pairing selection button 9 and the mode adjustment buttons 10 are arranged on the right side of the transmitter shell 3. The pairing selection button 9 is electrically connected to the selection module, and the pairing selection button 9 is pressed to trigger the selection module to realize selection of different receivers 2. The mode adjustment buttons 10 include a vibration adjustment button 11 and an electric shock adjustment button 12. The vibration adjustment button 11 is electrically connected to the vibration adjustment module, and the vibration adjustment module is triggered by pressing the vibration adjustment button 11, to switch the transmitter 1 into a vibration mode, and vibration gears of the receiver 2 are adjusted by rotating the switch 5. The vibration adjustment module generates a vibration instruction after adjustment. Similarly, the electric shock adjustment button 12 is electrically connected to the electric shock adjustment module, the electric shock adjustment module is triggered by pressing the electric shock adjustment button 12 to switch the transmitter 1 into an electric shock mode, electric shock gears of the receiver 2 are adjusted by rotating the switch 5, and the shock adjustment module generates an electric shock instruction after adjustment. A window is arranged on the surface of the transmitter shell 3, and a display screen 13 mounted in the transmitter shell 3 is arranged under the window. A sound button 14 and a vibration button 15 are arranged side by side on the surface of the transmitter shell 3 below the display screen 13. The sound button 14 is electrically connected to a sounding component, and a sound instruction is input by pressing the sound button 14 and is sent to the receiver 2 matched with the transmitter 1 through the antenna 6. The vibration button 15 is electrically connected to the vibration adjustment module. The vibration button 15 sends the vibration instruction generated by the vibration adjustment module to the receiver 2 matched with the transmitter 1 through the antenna 6. An electric shock button 16 and an electric shock strengthening button 17 both electrically connected to the shock adjustment module are also arranged below the sound button 14 and the vibration button 15. By pressing the electric shock button 16 or the electric shock strengthening button 17, the electric shock instruction generated by the electric shock adjustment module is sent to the receiver 2 matched with the transmitter 1 through the antenna 6, herein when the electric shock strengthening button is pressed, an electric shock instruction with a slightly higher strength than the current gear may be sent. Each time the electric shock strengthening button 17 is pressed, the electric shock strength value will increase by 10% of the original electric shock strength value.

Based on the above embodiment, as a preferred implementation manner, the receiver 2 includes a receiver shell 18, and a PCB, a vibration motor, a power supply component, and a sounding component respectively arranged in the receiver shell 18. The vibration motor, the power supply component and the sounding component are respectively electrically connected to the PCB. A top cover 36 is arranged on the top of the receiver shell 18 and is provided with sound holes 37 that penetrate its wall and communicate with the inside of the receiver shell 18. A plurality of electric shock heads 19 are arranged at the bottom of the receiver shell 18, the number of electric shock heads 19 is optimally but not limitedly selected as two, and the two electric shock heads 19 are optimally but not limitedly selected as metal electric shock heads 19. The two electric shock heads 19 are mounted at the bottom of the receiver shell 18 at a certain interval in parallel, and located on one bottom side of the receiver shell 18. A protrusion 38 is arranged on the opposite side of the two electric shock heads 19, the protrusion 38 and the receiver shell 18 are integrally molded, and the protrusion 38 and the two electric shock heads 19 are distributed triangularly, so that the electric shock heads 19 can better contact the pet's skin and make the electric shock more stable. The sounding component is arranged under the sound holes 37.

Based on the above embodiment, as a preferred implementation manner, only two electric shock heads 19 can be arranged at the bottom of the receiver 2. In the case where the protrusion 38 is not provided, the two electric shock heads 19 are arranged in the middle of the bottom of the receiver shell 18 in an array at a certain interval.

Based on the above embodiment, as a preferred implementation manner, the PCB board is provided with a signal receiving module, and an electric shock module, a vibration module, a power supply module, and a sounding module respectively electrically connected to the signal receiving module; the signal receiving module and a signal sending module are in wireless communication connection, and the signal receiving module receives a signal sent by the antenna 6 on the signal sending module, thereby achieving sending and receiving of the wireless signal between the transmitter 1 and the receiver 2.

In the embodiment, during use, firstly the switch 5 on the transmitter 1 is rotated to turn on the transmitter 1 while the power switch 20, arranged on the receiver shell 18, of the receiver 2 is pressed to turn on the receiver 2; a pairing state is entered by pressing and holding the power switch 20 on the receiver 2, with a green indicator light on the receiver 2 quickly flashing; whether the lock icon is displayed on the display screen 13 is observed, if the lock icon is displayed, then after the unlock button 8 is pressed, the display screen 13 displays the unlock icon, and operations of other buttons can be carried out. There are four dog head icons on the display screen 13. In an unlock state, the pairing selection button 9 is pressed to make one of the dog head icons on the display screen 13 flashing, the corresponding numbers 1, 2, 3 and 4 may be displayed, and each number corresponds to the order of one receiver 2. Through the pairing selection button 9, the number of the receiver 2 that needs to be used is selected, so that the receiver 2 is matched with the transmitter 1. When the pairing is successful, the green indicator light of the receiver 2 may flash slowly. Then, the vibration adjustment button 11 or the electric shock adjustment button 12 is pressed to switch the transmitter 1 into a vibration or electric shock mode. When the vibration adjustment button 11 or the shock adjustment button 12 is pressed, the switch 5 is rotated to adjust the corresponding vibration frequency gear or electric shock strength gear. Here, the vibration gear range is 0-9 gears, and the electric shock gear range is 0-99 gears. When an electric shock strength gear setting value is greater than or equal to 50, the display screen 13 will display a warning icon. When the vibration button 15 on the front of the transmitter 1 is pressed, the vibration icon on the display screen 13 will flash. Then, the receiver 2 matched with the transmitter 1 will receive a vibration instruction to drive the vibration motor to vibrate. When the electric shock button 16 is pressed, the electric shock icon on the display screen 13 will flash, and the receiver 2 matched with the transmitter 1 will receive the electric shock instruction and drive the electric shock module, and the electric shock heads 19 will perform the electric shock operation with the corresponding strength on the pet. When the electric shock strengthening button 17 is pressed, the electric shock heads 19 will carry out an electric shock with a strength slightly higher than the setting value to the pet. By designing the electric shock button 16 and the electric shock strengthening button 17 on the transmitter 1, an effect of fast switching of the electric shock strength is realized to produce electric shocks with different strengths to pets. In addition, in this embodiment, four receivers 2 are selected, and four corresponding dog head icons are displayed on the display screen 13. However, when there are one, two or three receivers, the receivers 2 can also be matched with the four dog head icons to achieve normal use.

Based on the above embodiment, as a preferred embodiment, in order to deal with pet dogs with different hair lengths and thicknesses, each receiver 2 is provided with conductive silicone sleeves and insulating silicone sleeves of different lengths. When the pet dog using the receiver 2 has the hair relatively small and short, short conductive silicone sleeves can be set on the two electric shock heads 19. When the pet dog using the receiver 2 has the hair relatively more and long, the two electric shock heads 19 can be sleeved with long conductive silicone sleeves. Use of the conductive silicone sleeves on the electric shock heads 19 can prevent metal from directly contacting the pet's skin so as to reduce damage to the pet's skin. Secondly, when a user does not want to electrically shock the pet or worry about being electrocuted, he can cover the two electric shock heads 19 with the insulating sleeves, which can effectively achieve a protection effect.

Based on the above embodiment, as a preferred implementation manner, when the sound button 14 on the front of the transmitter 1 is pressed, the sound icon on the display screen 13 will flash, and the receiver 2 matched with the transmitter 1 will emit a warning sound “beep, beep”; and the sounding component may be a loudspeaker or a buzzer, or the like.

Based on the above embodiment, as a preferred implementation manner, every time the button on the transmitter 1 is pressed, a green indicator light of the transmitter 1 will flash, and the green indicator light on the receiver 2 matched with it will be on for a long time. When the transmitter 1 is turned on, the switch 5 can be rotated to turn off the transmitter 1. When the receiver 2 is turned on, the receiver 2 can be turned off by pressing and holding the power switch 20 thereon.

Based on the above embodiment, as a preferred implementation manner, when the receiver 2 is in an off state, the receiver 2 is turned on by pressing the power switch 20 thereon, the green indicator light on the receiver 2 may slowly flash; in addition, the receiver 2 enters a pairing state by pressing and holding the power switch 20 on the receiver 2, then the green indicator light on the receiver 2 may quickly flash.

Based on the above embodiment, as a preferred implementation manner, the receiver 2 adopts a magnetic charger connector 40, so that the overall waterproof performance of the receiver 2 is effectively improved, and a charging manner is simplified; in addition, power of the transmitter 1 and the receiver 2 can be respectively displayed on the display screen 13, thereby facilitating use.

All or part of the embodiments may be implemented by software, hardware, firmware or any combination thereof. In case of implementation with the software, all or part of the embodiments may be implemented in form of a computer program product. The computer program product includes one or more computer instructions. When the computer instructions are loaded and executed on a computer, the flows or functions according to the embodiments of the disclosure are all or partially formed. The computer may be a universal computer, a dedicated computer, a computer network or another programmable device. The computer instructions may be stored in a computer-readable storage medium or transmitted from one computer-readable storage medium to another computer-readable storage medium. For example, the computer instructions may be transmitted from one website, computer, server or data center to another website, computer, server or data center in a wired (for example, coaxial cable, optical fiber and Digital Subscriber Line (DSL) or wireless (for example, infrared, wireless and microwave) manner. The computer-readable storage medium may be any available medium accessible for the computer or data storage equipment including one or more integrated available media such as a server and a data center. The available medium may be a magnetic medium (for example, a floppy disk, a hard disk and a magnetic tape), an optical medium (for example, a Digital Versatile Disc (DVD), a semiconductor medium (for example, a Solid State Disk (SSD)) or the like.

Those of ordinary skill in the art may understand all or part of the flows implementing the method of the embodiments and they may be completed by related hardware instructed by a computer program. The program may be stored in a computer-readable storage medium, and when the program is executed, the flow of the each method embodiment may be included. The foregoing storage medium includes various media that can store program codes, such as a Read Only Memory (ROM), a RAM, a magnetic disk or an optical disc.

The last thing to be noted is: the above embodiments are only used to illustrate the technical solutions of the disclosure and not used to limit the same. Although the disclosure has been described in detail with reference to the foregoing embodiments, for those skilled in the art, they can still modify the technical solutions described in the foregoing embodiments, or equivalently replace part of the technical features; all these modifications and replacements shall not cause the essence of the corresponding technical solutions to depart from the spirit and scope of protection of the disclosure.

1. An intelligent dog training apparatus, comprising a transmitter and at least one receiver matched with the transmitter, wherein the transmitter and the at least one receiver are in communication connection through wireless signals;
the receiver comprises a receiver shell, a receiving unit, a vibration motor, a sounding component, and a plurality of electric shock heads; the receiving unit, the vibration motor and the sounding component are mounted in the receiver shell, and the receiving unit is connected to the electric shock heads, the vibration motor, and the sounding component;
the transmitter comprises a transmitter shell, and a transmitting unit and a control unit both arranged in the transmitter shell and electrically connected to each other, wherein the control unit is connected to a pairing selection button, a vibration button, a sound button, an electric shock button, and an electric shock strengthening button; in a pairing state, the pairing selection button searches for one or multiple receivers, matched with the transmitter, within an effective control range of the transmitter, and establishes a connection with the one or multiple receivers; in a selecting state, the pairing selection button selects to lock any one of the receivers that establish a connection with the transmitter to enable the receiving unit on the receiver that is selected to be locked to receive a control signal sent by the transmitting unit on the transmitter, and transmits the control signal to the electric shock heads or the vibration motor or the sounding component; the vibration button is configured to generate a vibration control signal, and the vibration control signal is sent to the receiver through the transmitting unit, so as to drive the vibration motor on the receiver to work; the sound button is configured to generate a sound control signal for controlling the receiver to make a sound; the electric shock button is configured to generate an electric shock control signal, and the shock control signal is sent to the receiver through the transmitting unit, so as to drive the electric shock heads on the receiver to work; the electric shock strengthening button is configured to generate a strength increasing signal according to a first preset proportion, and the strength increasing signal is sent to the receiver through the transmitting unit, so that an electric shock strength of each of the electric shock heads in a working state currently is increased according to the first preset proportion.

2. The intelligent dog training apparatus as claimed in claim 1, wherein the transmitter comprises a first Printed Circuit Board (PCB) mounted in the transmitter shell, the control unit is arranged on the first PCB, the transmitting unit comprises an antenna arranged on the outer side of the transmitter shell, a switch connected to the control unit is also arranged on the outer side of the transmitter shell, and the antenna is electrically connected to the control unit.

3. The intelligent training dog apparatus as claimed in claim 1, wherein the transmitter shell is further provided with a display screen that is configured to at least display a real-time pairing state of the transmitter and the receiver, a selection locking state, an electric shock strength state, a vibration strength state, and a power state;
the transmitter shell is further provided with mode adjustment buttons, and the mode adjustment buttons comprise a vibration adjustment button and an electric shock adjustment button both arranged on a first side of the transmitter shell; the vibration adjustment button is configured to generate a vibration frequency signal for adjusting a vibration frequency of the vibration motor, and the electric shock adjustment button is configured to generate an electric shock strength signal for adjusting the electric shock strength of each of the electric shock heads; and
a lock button and an unlock button both electrically connected to the control unit are arranged on a second side of the transmitter shell; the lock button is configured to enable the transmitter to enter a lock state when receiving a lock operation instruction to shield signals of other buttons except that of the unlock button, so that the transmitter cannot transmit signals to the receiver; the signals comprise the sound control signal, the strength increasing signal, the electric shock strength signal, and the vibration frequency signal; and the unlock button is configured to release the lock state when receiving an unlock operation instruction.

4. The intelligent dog training apparatus as claimed in claim 1, wherein the electric shock heads may be detachably covered with conductive rubber sleeves or insulating silicone sleeves, respectively.

5. The intelligent dog training apparatus as claimed in claim 1, wherein the receiver is provided with a magnetic charger connector, a storage battery and a charging indicator light both electrically connected to the magnetic charger connector, and mode LED lights for displaying a pairing mode and a charging mode; and
the transmitter is provided with a Micro interface for charging, a storage battery and a charging indicator light both connected to the Micro interface, and mode LED lights for displaying a pairing mode and a charging mode.

6. The intelligent training dog as claimed in claim 2, wherein the control unit comprises a master control module, and a switch module, a vibration adjustment module, an electric shock adjustment module, a selection module, a lock module, a sound module, and a transmission module which are respectively electrically connected to the master control module;
the transmission module is connected to the antenna, and configured to receive signals generated by the switch module, the vibration adjustment module, the electric shock adjustment module, the selection module, and the sound module, and send the signals to the receiver;
the switch module is electrically connected to the switch, and an on or off state of the transmitter is controlled by rotating the switch; the vibration adjustment module is electrically connected to the vibration adjustment button, and vibration gears of the transmitter are adjusted by rotating the switch when the vibration adjustment button is pressed, so that a vibration frequency of the receiver is controlled;
the electric shock adjustment module is electrically connected to the electric shock adjustment button, and electric shock gears are adjusted by rotating the switch when the electric shock adjustment button is pressed, so that an electric shock strength of the receiver is controlled;
the selection module is electrically connected to the pairing selection button, the selection module is controlled to select any one of the receivers connected to the transmitter by pressing and holding the pairing selection button while rotating the switch, so that the receiver that is selected to be locked is controlled;
the sound module is electrically connected to the sound button, and a sound control signal is generated by pressing and holding the sound button, and is transmitted to the transmission module; and
the lock module is electrically connected to the lock button and the unlock button, and is controlled to lock the pairing selection button, the mode adjustment buttons, the sound button, the vibration button, the electric shock button, and the electric shock strengthening button on the transmitter through the lock button and the unlock button, so as to temporarily disable corresponding functions, or unlock these buttons to recover their functional operations.

7. The intelligent dog training apparatus as claimed in claim 6, wherein the receiver comprises a second PCB mounted in the receiver shell, and the second PCB is provided with an electric shock module, a vibration module, and a sounding module which are electrically connected to the receiving unit; the electric shock module is configured to receive an electric shock strength signal sent by the electric shock adjustment module to drive the electric shock heads that are electrically connected to the electric shock module to carry out an electric shock operation; the vibration module is configured to receive the vibration frequency signal sent by the vibration adjustment module to drive the vibration motor that is electrically connected to the vibration module to carry out an vibration operation; the sounding module is electrically connected to the sounding component and configured to receive the sound control signal and control the sounding component to make a sound.

8. The intelligent dog training apparatus as claimed in claim 7, wherein the receiver shell is provided with a top cap, the top cap is provided with a plurality of sound holes at positions corresponding to the sounding component, and the sounding component refers to a loudspeaker or a buzzer.

9. The intelligent dog training apparatus as claimed in claim 3, wherein the plurality of electric shock heads are respectively arranged on a bottom side of the transmitter shell, a protrusion is integrally molded at the bottom of the transmitter shell, and located on the other side, opposite to the plurality of electric shock heads, and the plurality of electric shock heads and the protrusion form a triangular structure so that contact degree and electric shock stability are improved.

10. The intelligent dog training apparatus as claimed in claim 9, wherein the magnetic charger connector is arranged on the protrusion.

11. The intelligent dog training apparatus as claimed in claim 1, wherein tops of the plurality of electric shock heads are located at the same horizontal position to keep an effective contact; the plurality of electric shock heads are arranged at the bottom of the transmitter shell, and distributed in the middle of the bottom of the transmitter shell.

12. The intelligent dog training apparatus as claimed in claim 6, wherein the master control module is configured to transmit control signals of the transmitter, generated through operations of the pairing selection button, the mode adjustment button, the sound button, the vibration button, the electric shock button, and the electric shock strengthening button, and send the control signals to one or multiple receivers matched with the transmitter; the receiving unit in each receiver, which is in wireless communication connection with the master control module, receives the signals transmitted by the master control unit so as to perform wireless communication connection between the transmitter and the receiver.

13. A control method, based on the intelligent dog training apparatus according to of claim 1, comprising:
(1) startup: rotating a switch on a transmitter to turn on the transmitter, pressing a switch of a receiver matched with the transmitter to turn on the receiver; on a display screen, displaying a real-time power icon of the transmitter, and a real-time power icon of the receiver matched with the transmitter during pairing of the receiver and the transmitter; and initially controlling parameters which comprise an electric shock strength and a vibration frequency;
(2) selection: after pairing is completed, pressing a pairing selection button, rotating the switch to allow the corresponding icon of the receiver to flash on the display screen until the receiver is selected;
(3) adjustment: pressing a vibration adjustment button or an electric shock adjustment button to switch the transmitter into a corresponding mode, rotating the switch to adjust gears unit reaching a vibration amplitude or electric shock strength required for training;
(4) training: when a pet wears the receiver, according the actual training, pressing and holding the vibration adjustment button while rotating the switch to adjust the vibration gears of the transmitter so as to generate a vibration frequency signal, then pressing the vibration button to generate a vibration control signal based on the vibration frequency signal, sending the vibration control signal to the receiver, and after the receiver receives the vibration control signal, driving a vibration motor to achieve vibration with a corresponding strength;
pressing and holding the electric shock button while rotating the switch to adjust electric shock gears of the transmitter to generate an electric shock strength signal, then pressing the electric shock button to generate an electric shock control signal based on the electric shock strength signal, sending the electric control signal to the receiver, and after the receiver receives the electric shock control signal, driving the electric shock heads to carry out an electric shock with a corresponding strength;
wherein when the vibration frequency or the electric shock strength exceeds a preset value, a warning icon of the transmitter will flash on the display screen;
wherein when a sound button on the transmitter is pressed, the receiver sends a prompt sound to warn the pet, so that the pet may stay still;
(5) standby: covering the electric shock heads with insulating silicone sleeves when training is not required;
(6) shutdown: rotating the switch on the transmitter to turn off the transmitter, and pressing a power switch on the receiver for 3 s to turn off the receiver; and
(7) charging: in the case of a low power, giving a low-power warning, charging the transmitter through a Micro interface, and charging the receiver through a magnetic charger connector.
